(19) United States
(12) Patent Application Publication
(10) Pub. No.: US 2002/0038461 A1
(43) Pub. Date: Mar. 28, 2002

(54) Radio-frequency communications redundancy

(76) Inventors: Gerard White, Dunstable, MA (US); Patrick A. Gerber, Boston, MA (US)

Correspondence Address: MINTZ, LEVIN, COHN, FERRIS,, GLOVSKY and POPEO, P.C., One Financial Center, Boston, MA, 02111, US

(21) Appl. No.: 09/836,761

(22) Filed: Apr. 18, 2001

Related U.S. Application Data
(60) Provisional application No. 60/198,294, filed on Apr. 19, 2000.

(51) Int. Cl. H04N 7/173

(52) U.S. Cl. 725/129; 725/111

(57) ABSTRACT

A cable modem termination system (CMTS) for receiving signals from, and transmitting signals toward, a High-Frequency Coax plant includes multiple normally-active CMTSs each configured to receive and transmit modem-compatible signals, multiple interface modules coupled to the normally-active CMTSs and configured to convey data toward the HFC from the normally-active CMTSs and from the HFC toward the normally-active CMTSs, and a spare CMTS configured to receive and transmit modem-compatible signals, where at least two interface modules are coupled to each other in a daisy-chain fashion to couple at least a first of the interface modules to the spare CMTS via at least a second of the interface modules to which the first interface module is daisy-chain coupled.

### CROSS-REFERENCE TO RELATED APPLICATIONS

This application claims the benefit of U.S. Provisional Application No. 60/198,294, filed Apr. 19, 2000, and entitled “RADIO FREQUENCY COMMUNICATIONS REDUNDANCY”.

### BACKGROUND OF THE INVENTION

The invention relates to communications and more particularly to communications, including telephony communications, using a Radio Frequency (RF) interface such as a cable modem system or a wireless modem system.

Demand for more and faster information communication continues to increase. To accommodate the increasing needs and demands for information, high-speed communication technology has evolved. Included in this technology are cable transmission lines and cable modems.

A head end cable plant can service large areas with cable communication lines. The plant is typically left unattended for large periods of time and includes Cable Modem Termination Systems (CMTSs) that serve different portions of the serviced area. Cable lines connect the CMTSs to various regions of the serviced area. Each CMTS transmits and receives data to and from its assigned region of the serviced area. The amount of downtime permissible for a CMTS arrangement is on the order of 0.01% (i.e., minimum 99.99% availability) for telephony applications.

### SUMMARY OF THE INVENTION

Embodiments of the invention provide techniques for replacing a failed CMTS with a spare, operational CMTS. Embodiments of the invention also provide redundancy for wireless communications.

In general, in an aspect, the invention provides a CMTS system for receiving signals from, and transmitting signals toward, a High-Frequency Coax plant. The system includes multiple normally-active CMTSs each configured to receive and transmit modem-compatible signals, multiple interface modules coupled to the normally-active CMTSs and configured to convey data toward the HFC from the normally-active CMTSs and from the HFC toward the normally-active CMTSs, and a spare CMTS configured to receive and transmit modem-compatible signals, where at least two interface modules are coupled to each other in a daisy-chain fashion to couple at least a first of the interface modules to the spare CMTS via at least a second of the interface modules to which the first interface module is daisy-chain coupled.

Implementations of the invention may include one or more of the following features. The system may further include a switch mechanism configured to selectively couple the spare CMTS to at least two interface modules independently of any other of the interface modules.

The at least one of the at least two interface modules are further coupled to another interface module in a daisy-chain fashion. The switch mechanism is configured to, in response to a normally-active CMTS becoming at least imminently non-active, couple the spare CMTS to an interface module associated with the normally-active CMTS that is at least imminently non-active.

Each interface module corresponds to a respective normally-active CMTS, the interface modules each including an upstream input port and a downstream output port, and wherein each interface module is configured to couple its downstream output port and upstream input port to its respective normally-active CMTS while the respective normally-active CMTS is operational and to the spare CMTS otherwise. Each interface module is configured to couple its downstream output port and upstream input port to its respective normally-active CMTS while bypassing the spare CMTS. The first and second interface modules are selectively coupled to each other in a daisy-chain fashion, the second interface module being configured to decouple the first interface module from the spare CMTS while the second interface module couples its upstream input port and downstream output port to the spare CMTS.

The spare CMTS includes a diagnostic cable modem configured to detect errors in the normally-active CMTSs. The diagnostic cable modem is configured to test the normally-active CMTSs.

In general, in another aspect, the invention provides a CMTS system for receiving signals from, and transmitting signals toward, a High-Frequency Coax plant. The system includes multiple normally-active CMTSs each configured to receive and transmit modem-compatible signals, multiple input/output (I/O) modules each associated with a respective normally-active CMTS, a spare CMTS configured to receive and transmit modem-compatible signals, and coupling means for serially coupling at least two of the I/O modules associated with normally-active CMTSs to the spare CMTS.

Implementations of the invention may include one or more of the following features. The coupling means is configured to selectively couple an input and an output of the spare CMTS to an output and an input of one of the I/O modules associated with one of the normally-active CMTSs that is at least imminently non-active. The coupling means is configured to selectively couple to at least a third of the I/O modules associated with a normally-active CMTS independently of the at least two I/O modules that are serially coupled by the coupling means.

In general, in another aspect, the invention provides a method of providing one-to-N redundancy for N normally-active cable modem terminal system (CMTS) data transfer units using a spare CMTS, the method including providing the spare CMTS and the N normally-active CMTS data transfer units, providing coupling of at least two of the CMTS data transfer units to each other, and monitoring the normally-active data transfer units for de-activation.

Implementations of the invention may include one or more of the following features. The method may further include coupling at least one of M of the CMTS data transfer units to the spare CMTS in response to one of the N CMTS data transfer units being at least imminently deactivated, where M is less than N. The at least one of M of the CMTS data transfer units is coupled to the spare CMTS in response to one of the N CMTS data transfer units being deactivated. The at least one of M of the CMTS data transfer units is coupled to the spare CMTS in response to one of the N CMTS data transfer units failing. The at least one of M of the CMTS data transfer units is coupled to the spare CMTS using a one-to-M switch.

Implementations of the invention may include one or more of the following features. Coupling is provided to the spare CMTS of exactly one of the at least two of the CMTS data transfer units independent of any other CMTS data transfer unit. The method may further include coupling the spare CMTS to at least a selected one of the at least two CMTS data transfer units in response to the selected one of the at two CMTS data transfer units being at least imminently de-activated, and de-coupling from the spare CMTS any CMTS data transfer units disposed electrically further from the spare CMTS than the selected one of the at least two CMTS data transfer units. The CMTS data transfer units each include a CMTS and an input/output module, and wherein the providing coupling includes providing daisy-chain coupling of the input/output modules of the at least two CMTS data transfer units.

In general, in another aspect, the invention provides a CMTS system for receiving signals from, and transmitting signals toward, a High-Frequency Coax plant. The system includes a plurality of normally-active CMTSs each configured to receive and transmit modem-compatible signals, a plurality of interface modules coupled to the normally-active CMTSs and configured to convey data toward the HFC from the normally-active CMTSs and from the HFC toward the normally-active CMTSs, and a spare CMTS configured to receive and transmit modem-compatible signals, a switch mechanism configured to selectively couple the spare CMTS to at least two interface modules independently of any other of the interface modules, where at least two interface modules are coupled to each other in a daisy-chain fashion to couple at least a first of the interface modules to the spare CMTS via at least a second of the interface modules to which the first interface module is daisy-chain coupled, and where each interface module corresponds to a respective normally-active CMTS, the interface modules each including an upstream input port and a downstream output port, and each interface module is configured to couple its downstream output port and upstream input port to its respective normally-active CMTS, while bypassing the spare CMTS, while the respective normally-active CMTS is operational and to the spare CMTS otherwise.

Various embodiments of the invention may provide one or more of the following advantages. Downtime of CMTSs can be guarded against. Low mean time to repair of CMTSs can be provided. Emergency repair costs can be reduced compared to conventional CMTS systems. Support for 1-to-N CMTS redundancy can be provided (thereby avoiding expenses and excessive space requirements of providing 1-to-1 redundancy). High-availability services (e.g., requiring 99.99% uptime) can be provided using CMTSs. A failing CMTS can be replaced with little or no noticeable effects by a user in communication with the CMTS. Similar advantages can be achieved for wireless communications. High frequency of CMTS downstream signals, with which cable modems operate, can be accommodated with proper termination and emission control.

These and other advantages, and the invention itself, will be more apparent from the following drawings, description, and claims.

### BRIEF DESCRIPTION OF THE DRAWINGS

FIG. 1 is a schematic diagram of a portion of a redundant CMTS system.

FIG. 2 is a schematic diagram of an input/output module including a relay for upstream signal processing.

FIG. 3 is a schematic diagram of an input/output module including a relay for downstream signal processing.

FIG. 4 is a schematic block diagram illustrating bus-based selection of units of a redundant system during normal operation.

FIG. 5 is a schematic diagram of a cable modem termination system, a redundancy midplane, and an input/output module during normal operation.

FIG. 6 is a schematic diagram of three cable modem termination systems, a redundancy midplane, and three daisy-chain connected input/output modules during normal operation.

FIG. 7 is a block flow diagram of a process of using a spare CMTS for redundancy.

FIG. 8 is a logical block diagram illustrating downstream signal flow during normal operation of a redundant system.

FIG. 9 is a logical block diagram illustrating upstream signal flow during normal operation of a redundant system.

FIG. 10 is a schematic diagram of four cable modem termination systems, a redundancy midplane, and four input/output modules during failure of one of the cable modem termination systems.

FIG. 11 is a logical block diagram illustrating downstream signal flow during failure of a unit of the redundant system shown in FIG. 4.

FIG. 12 is a logical block diagram illustrating upstream signal flow during failure of a unit of the redundant system shown in FIG. 4.

FIG. 13 is a schematic diagram of a portion of an alternative redundant system.

FIG. 14 is a block flow diagram of a process of providing redundant CMTS service.

FIG. 15 is a schematic diagram of a portion of another redundant CMTS system.

FIG. 16 is a schematic diagram of a portion of the system shown in FIG. 15 showing details of a one-to-N switch.

FIG. 17 is a schematic block diagram of a hybrid redundant CMTS system.

### DETAILED DESCRIPTION OF PREFERRED EMBODIMENTS

Embodiments of the invention provide a spare CMTS associated with multiple active CMTSs. Each CMTS is connected to a corresponding input/output (I/O) module through a connection midplane. A detector can determine when an active CMTS fails and provide an indication of (e.g., a signal indicating) the failure. In response to the failure indication, cable connections are switched from the failed CMTS to the spare CMTS to restore service. In embodiments of the invention, this is accomplished under software control by having the I/O module connected to the spare CMTS route data to and from the I/O module of the failed CMTS that is connected to a cable plant to send data thereto and receive data therefrom. The I/O module of the failed CMTS disconnects the failed CMTS from the cable plant in response to the failure indication.

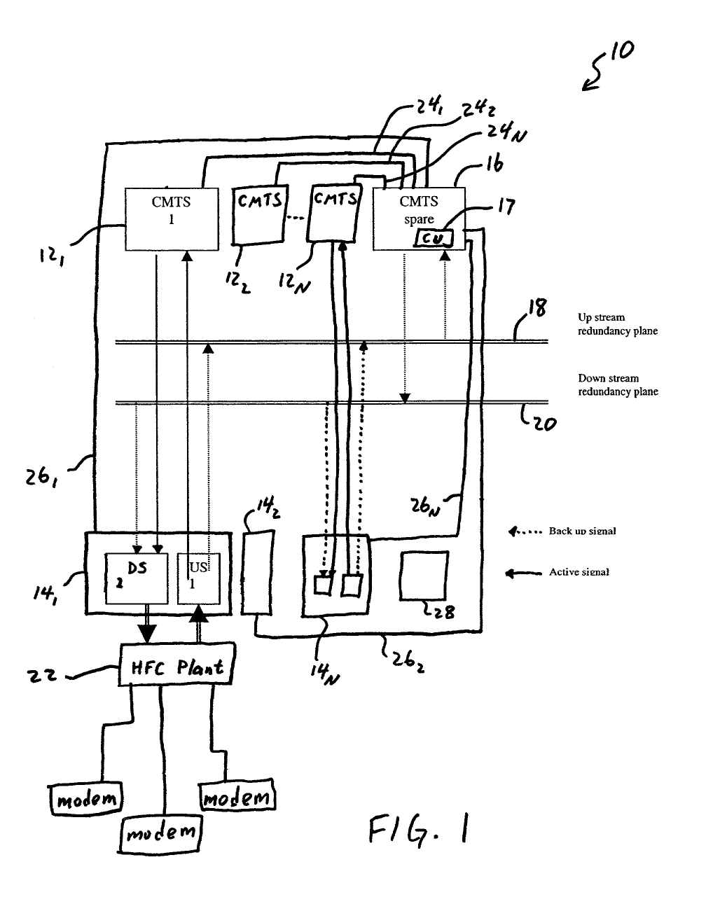

Referring to FIG. 1, a system 10, for providing 1-to-N redundancy for CMTSs, includes N normally-active CMTSs 12₁-12_{N} and N corresponding I/O modules 14₁-14_{N} and a spare CMTS 16. The CMTSs 12 are configured to control cable modem access to physical media through operation of an appropriate media access control protocol, monitor and manage cable modem operation, and forward IP traffic between cable modems and a backbone network. The CMTSs 12₁-12_{N} are each coupled as shown to modems 13₁-13_{N}, e.g., in end user's personal computers, for sending/receiving information to/from the CMTSs 12₁-12_{N}. The CMTSs 12₁-12_{N}, the redundancy planes 18, 20, and the I/O modules 14₁-14_{N}, along with software control are contained in a chassis 15 in a head end cable plant. Appropriate connectors are provided from each of the I/O modules 14 to lines connecting the chassis to a High-Frequency Coax (HFC) plant 22 (or HFC plants). Challenges for 1-to-N redundancy include: maintaining the states of the N CMTSs 12 in the spare CMTS 16, maintaining (by the spare CMTS 16) the state information for cable modems (CMs) attached to each CMTS 12 that the spare CMTS 16 may take over from, switching the spare CMTS 16 into the path of a failed CMTS's external coax lines, and dealing with 10 interfaces per CMTS.

As shown in FIG. 1, the CMTSs 12 are connected to associated I/O modules 14. The I/O modules 14 are connected to the HFC plant 22 and both the I/O modules 14 and the spare CMTS 16 are connected to an upstream redundancy plane 18 and a downstream redundancy plane 20. The I/O modules 14 serve as interfaces between the CMTSs 12 and the HFC 22. The spare CMTS 16 provides 1-to-N redundancy for the N CMTSs 12₁-12_{N} through the redundancy planes 18, 20. The CMTSs 12, 16 are adapted to transmit and receive radio frequency (RF) signals to/from the I/O modules 14, with signals to/from the spare CMTS 16 passing through the redundancy planes 18, 20, respectively. The normally-active CMTSs 12 drive RF signals to the cable plant 22 under normal operation (no errors). Signals from normally-active CMTSs 12 are connected (e.g., directly) to I/O modules 14 that are connected to the plant 22. The spare CMTS 16 is configured to take over for a failed normally-active CMTS 12. An output of the spare CMTS 16 is transmitted to all I/O modules, as described below, and selected by the module 14 requiring the output.

The I/O modules 14 are highly reliable modules that allow selection of signals to the plant 22 to be from an active CMTS 12 or from the redundancy planes 18, 20. Connections to the cable plant 22 are made from the CMTSs 12 through passive I/O modules 14 that have a simple design that helps give the I/O modules 14 a very high mean time between failure (MTBF). The I/O modules 14 are connected to the active CMTSs 12 and to the spare CMTS 16 via the redundancy planes 18, 20.

Relays are used to select the signal paths between the active CMTS and the redundancy planes. In the base mode of operation (no failures in the normally-active CMTSs 12₁-12_{N}) the relay is a passive device that helps it to have a very high MTBF even without being replicated. Upon a failure of a CMTS 12_{f}, a relay in a corresponding I/O module 14_{f} provides switching that is an active function. The relay is designed such that once the relay paths are established they remain operational even if active components (e.g., control signals) or power to the relay fail; the relay will remain in its current setting on power or control signal failure. The relays are distributed across all CMTS I/O modules 14.

The redundancy planes 18, 20 and the connections between the I/O modules 14 and the CMTSs 12 are implemented with a two-sided printed-circuit board (PCB) with appropriate connectors for passing the RF signals involved in system 10. Separate connectors are connected to the various I/O modules 14 and to the CMTSs 12, 16, respectively. Connecting lines on the board provide the redundancy plane (midplane) lines shown in the figures and the connections between the I/O modules 14 and the CMTSs 12. Signals are transported via electrical paths embedded in the PCB, for lower-frequency signals, and, for higher-frequency signals, lines constructed from coaxial cables and connectors that can provide greater RF isolation than that provided for the lower-frequency signals.

The spare CMTS 16 includes hardware and software, in a control unit 17, for monitoring the other CMTSs 12 through monitoring lines 24₁-24_{N}, and for controlling the I/O modules 14120 14_{N} through control lines 26₁-26_{N}. The spare CMTS software and hardware monitors the states of the other CMTSs 12 through monitor lines 24₁-24_{N} and detects failures, if any, in the CMTSs 12₁-12_{N}. When a failure occurs in a CMTS 12, e.g., CMTS 122, the software and/or hardware of the control unit 17 of the spare CMTS 16 can provide a control signal (e.g., “protect #2” in FIG. 5) over a corresponding control line 262 to control the states of switches in the I/O module 14₂ corresponding to the failed CMTS 122. The control signal causes the spare CMTS 16 to be connected through the redundancy midplanes 18, 20, and through the I/O module 14₂ of the failed CMTS 122 to the HFC plant 22.

RF Upstream

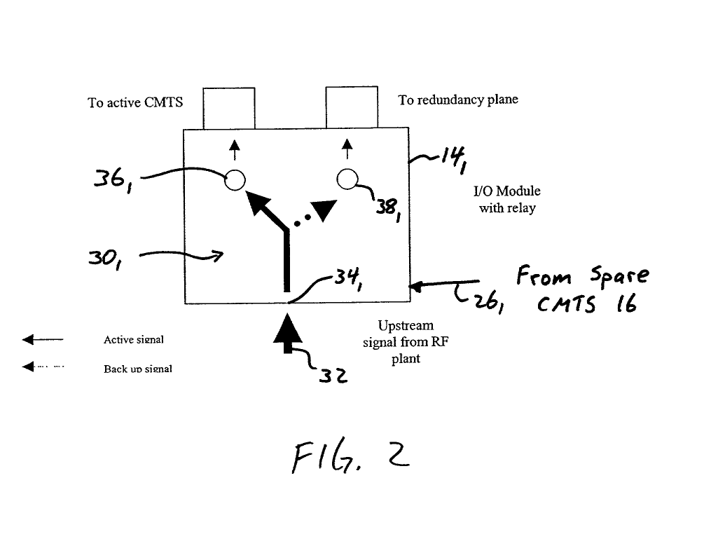

Referring also to FIG. 2, upstream RF signals (i.e., those in the direction from the plant 22 toward a CMTS 12, 16) use a redundancy model as shown in FIG. 2. Upstream signals from the plant 22 are received by an I/O module, e.g., module 141, as shown in FIG. 2. The I/O module 14₁ is equipped with a relay 30₁ that is configured to direct the upstream signal 32 (only one signal is shown) to either the module's associated normally-active CMTS 12₁ or to the upstream redundancy plane 18. The relay includes an input port 34₁, an upstream working port 36₁, and an upstream failure port 381. The I/O module 14₁ is configured to direct the signal 32 in response to and in accordance with an indication by the control signal from the spare CMTS 16 provided on control line 26₁ as to whether the normally-active CMTS 12₁ is performing properly or has failed. If the control signal indicates that the CMTS 12₁ is operating properly, then the relay 30₁ couples to the working port 36₁ to direct the signal 32 from the input port 34₁ to the working port 36₁ toward the CMTS 12₁ while bypassing the upstream redundancy plane 18. If the control signal indicates that the CMTS 12₁ has failed, then the relay 30₁ couples to the failure port 38₁ to direct the signal 32 from the input port 34₁ to the failure port 38₁ toward the upstream redundancy plane 18 to be received by the spare CMTS 16. The I/O modules 14 provide switching for 8 upstream lines per CMTS 12.

RF Downstream

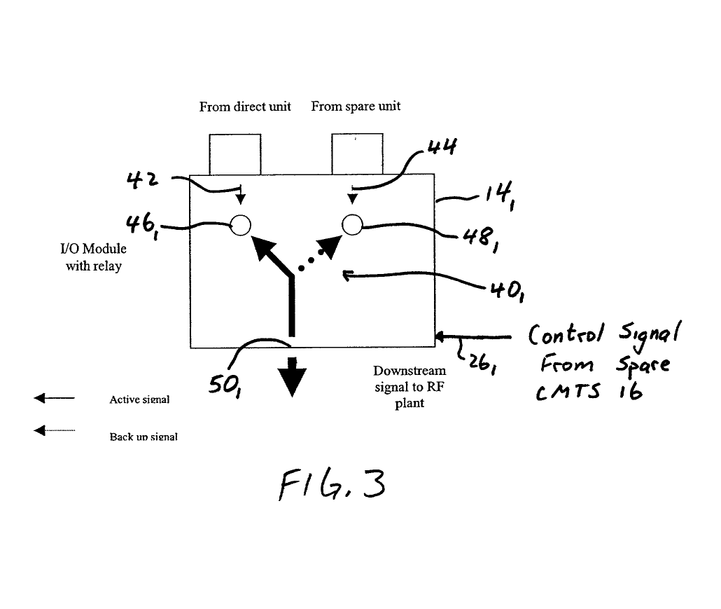

Referring to FIGS. 1 and 3, downstream signals (i.e., those in the direction from the CMTSs 12, 16 toward the plant 22) use a redundancy model as shown in FIG. 3. Downstream signals from a CMTS 12, 16 are received by an I/O module, e.g., module 14₁, as shown in FIG. 3. The I/O module 14₁ is equipped with a relay 40₁ that is configured to direct either a downstream signal 42 (only one signal is shown) from the module's associated active CMTS 12₁ or a downstream signal 44 from the downstream redundancy plane 20 to the plant 22. The relay includes a downstream working port 46₁, a downstream failure port 481, and an output port 501. The I/O module 14₁ is configured to direct the signals 42, 44 in response to and in accordance with an indication by the control signal from the spare CMTS 16 provided on control line 26₁ as to whether the CMTS 12₁ is performing properly or has failed. If the control signal indicates that the CMTS 12₁ is operating properly, then the relay 40₁ couples to the working port 46₁ to direct the signal 42 from the input port 46₁ from CMTS 12₁ while bypassing the downstream redundancy plane 20 to the output 50₁ toward the plant 22. If the control signal indicates that the CMTS 121 has failed, then the relay 40₁ couples to the failure port 481 to direct the signal 44 from the input port 48₁ from the spare CMTS 16 via the downstream redundancy plane 20 to the output port 50₁ toward the plant 22.

The I/O modules 14 provide switching for 2 downstream lines per CMTS 12. It is helpful to isolate the downstream RF plant 22 from a failed CMTS that is in an indeterminate state and may be producing spurious signals on its output 50. Selection of the output from the spare CMTS 16 via the I/O module relay 40 helps to achieve this.

Switch Topology

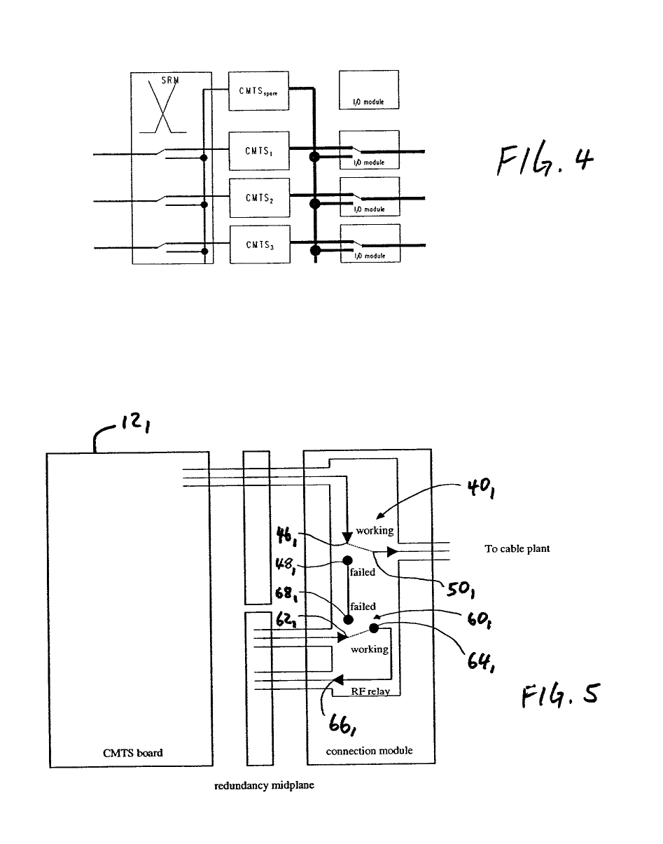

To switch the spare CMTS 16 into the path of a failed CMTS 12 using the relays 30, 40 (FIGS. 2-3), a path to/from (for downstream/upstream signals) the spare CMTS 16 is run to all the I/O modules 14 and the failed unit is selectively connected to this path. FIG. 4 schematically shows the path of the spare CMTS 16 being run to each of three I/O modules 14₁-14₃ with three CMTSs 12₁-12₃ being operational. A simple selection on every I/O module 14 can pick either the normally-active CMTS's connection or the spare CMTS's connection (using the redundancy planes 18, 20 (FIG. 1)).

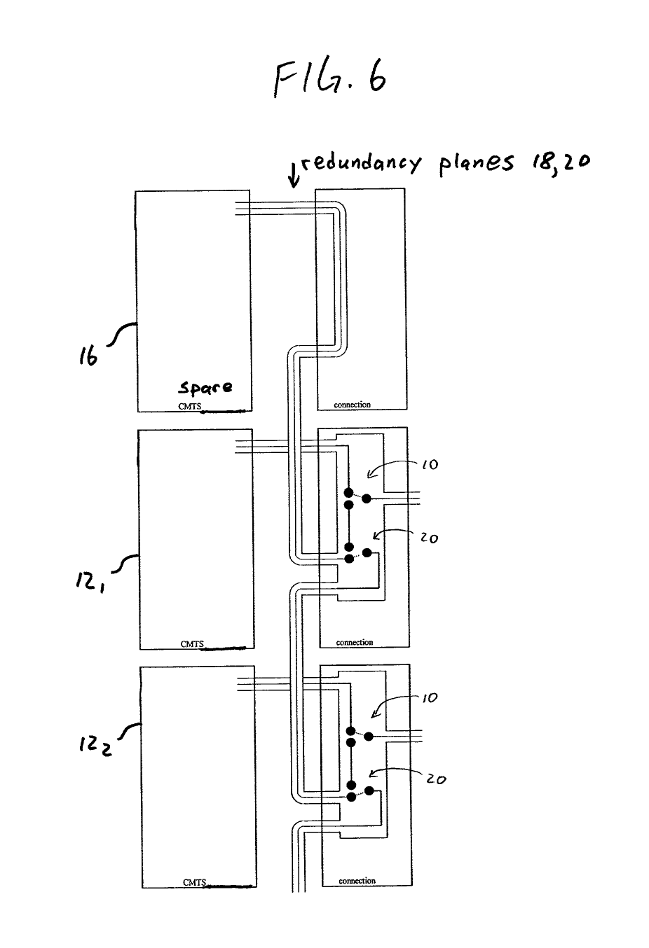

Conventional bussing of RF signals is replaced with a daisy chain mechanism implemented using RF relays as shown in FIGS. 5-6.

Referring to FIGS. 1 and 5, the relay 40₁ is configured such that during normal operation the switch 40₁ is positioned as shown to route a downstream signal as shown. Although, only one downstream switch is shown, FIG. 5 is applicable to at least one other downstream switch, and to upstream switches, with the arrowheads being reversed. The switch 40₁ connects the working port 46₁ to the output 50₁ to route signals from the CMTS 12₁ to the cable plant 22 while the CMTS 12₁ is active. If the CMTS 12₁ fails, the switch 40₁ will connect the output port 50₁ to the failed port 48₁.

The I/O module 14₁ also includes a daisy-chain switch 60₁ that is similar to the switch 40₁. During normal operation, the daisy-chain switch 60₁ connects a spare-in port 62₁ to a working port 64₁ that is connected to a daisy-out port 66₁ to provide a daisy-chain link for adjacent CMTSs through the redundancy midplane, plane 20 in FIG. 5. If the CMTS 12₁ fails, the switch 60₁ will couple the spare-in port 62₁ to a failed port 68₁ to route downstream signals from the spare CMTS 16 to the cable plant 22 through the failure port 48₁ and the output port 501.

Referring to FIGS. 1 and 5-6, during normal operation (no CMTS 12 failing), the switches 40, 60 shown in FIG. 5 for each I/O module provide a daisy-chain connection as shown in FIG. 6. The daisy-chain connection couples the spare CMTS 16 through the I/O modules 14₁-14₂ of the normally-active CMTSs 12₁-12₂, and couples the normally-active CMTSs 12₁-12₂ to the cable plant 22.

Operation

Referring to FIG. 1, redundancy control resides with the group of CMTSs 12, 16, and primarily with the spare CMTS 16 that acts as the redundancy control unit. Proper electric supply for the relays assures that in the absence or failure of the spare CMTS 16, the traffic flows straight through the I/O modules 14 to the CMTSs 12.

Signal distortion (due to, e.g., stubs in traces) may occur during the protective phase (during failure of a CMTS) in which case the modulation of the signal (lower bit rate) could resort to a more robust scheme (e.g., quadriture phase shift keying (QPSK) rather than quadriture amplitude modulation (QAM)).

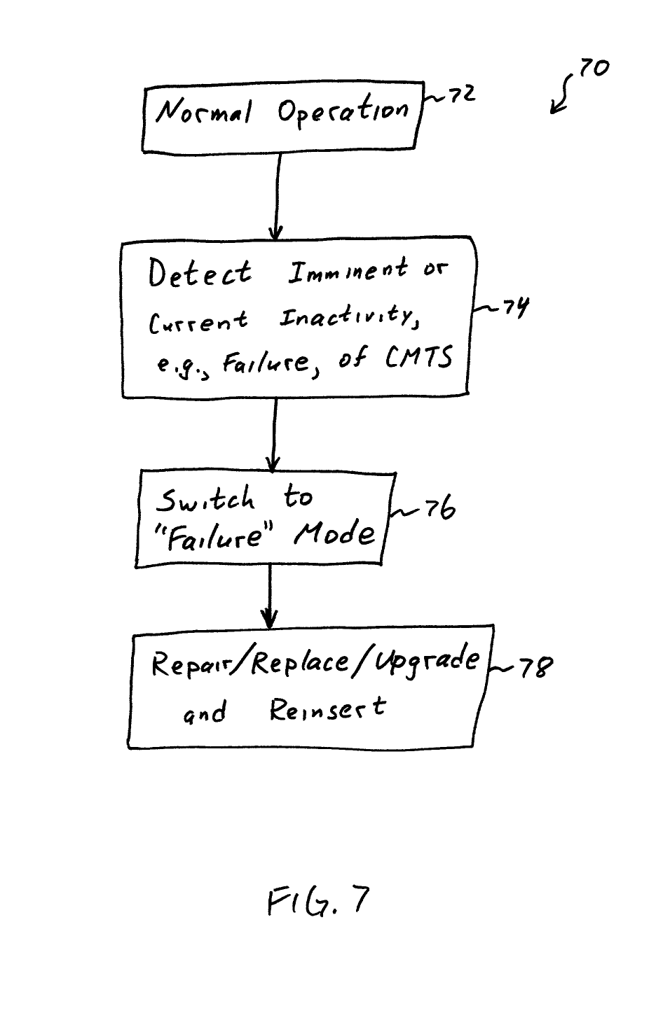

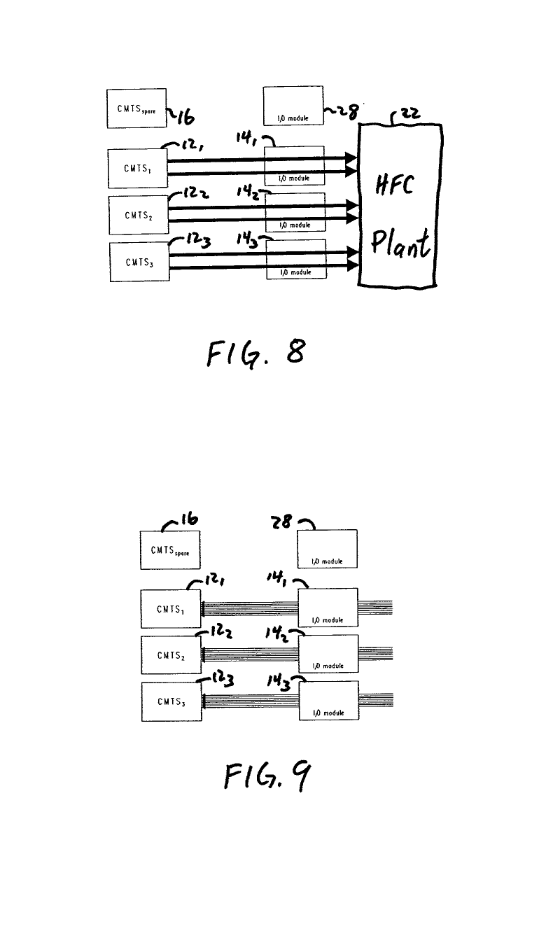

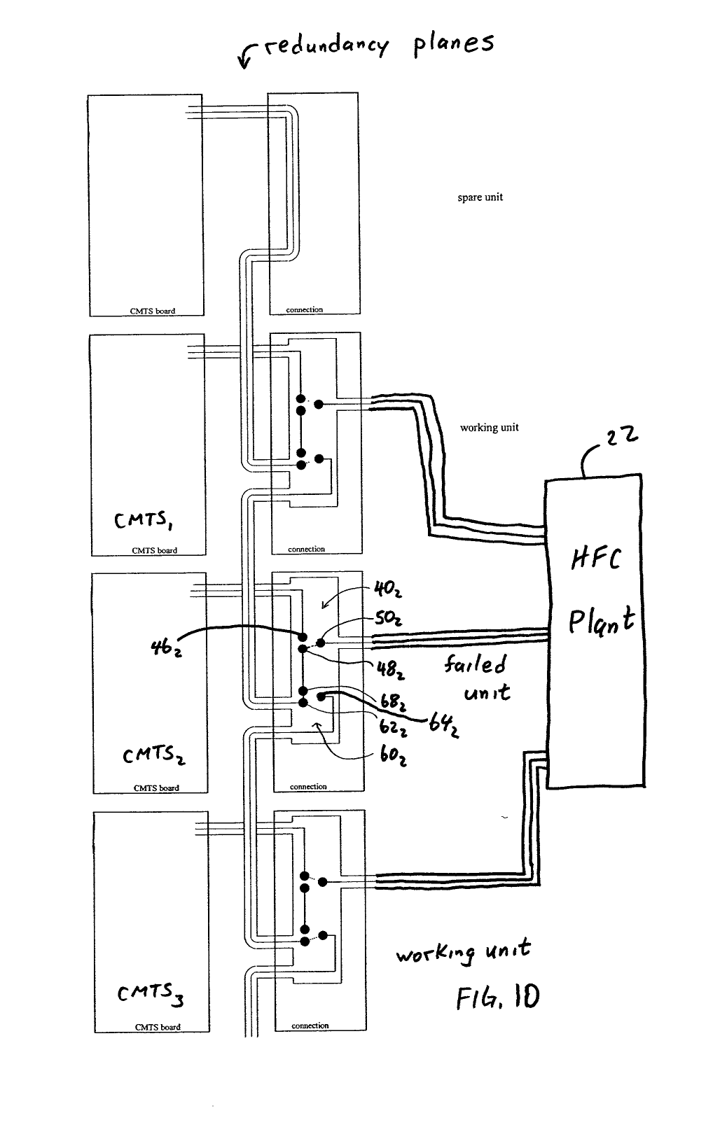

Referring to FIGS. 1 and 7, a process 70 of providing 1-to-N CMTS redundancy includes a step 72 in which normal operation of the system 10 is ongoing. In this stage, the spare CMTS 16 monitors the status of the normally-active CMTSs 12₁-12_{N} through the lines 24₁-24_{N}, and determines that all of the CMTSs 12₁-12_{N} are active and without failures. While the CMTSs 12₁-12_{N} are active, downstream signals are conveyed from the CMTSs 12₁-12_{N} through the I/O modules 14₁-14_{N}, as schematically shown for CMTSs 12₁-12₃ and I/O modules 14₁-14₃ in FIG. 8, while bypassing the downstream redundancy plane 20. While the CMTSs 12₁-12_{N} are active, upstream signals are conveyed from the CMTSs 12₁-12_{N} through the I/O modules 14₁-14_{N}, as schematically shown for CMTSs 12₁-12₃ and I/O modules 14₁-14₃ in FIG. 9, while bypassing the upstream redundancy plane 18.

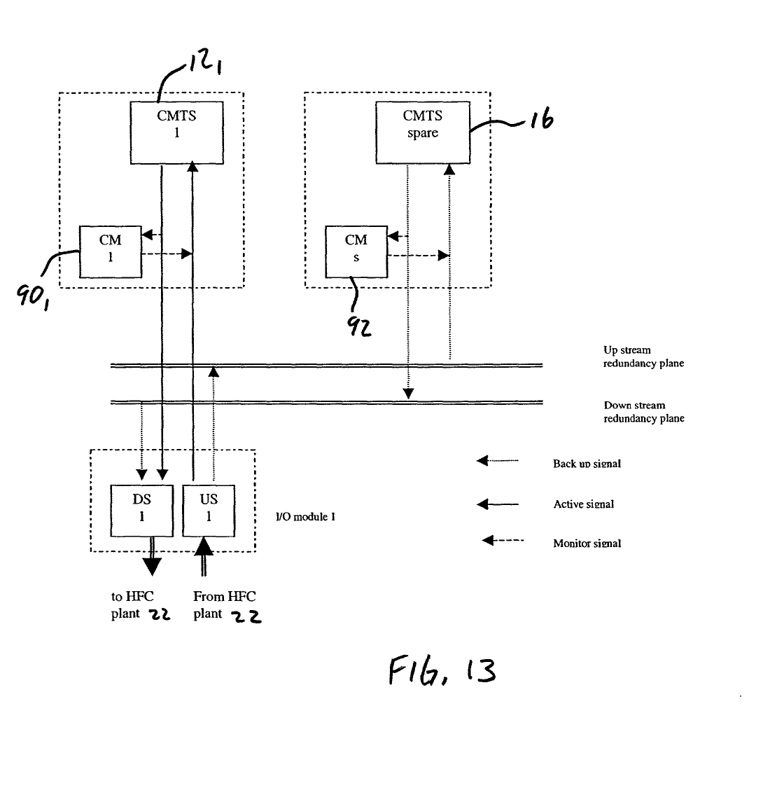

At stage 74, the control unit 17 of the spare CMTS 16 detects that CMTS 122 will imminiently be, or currently is, inactive, e.g., has failed or will be de-activated, and issues a control signal protect #2 (see FIGS. 11-12) on the control lines 26₁-26_{N} indicating the failure in CMTS 12₂. The control signal is sent to each I/O module 14, although FIGS. 11-12 only show the control signal being sent to the I/O module 14₂ associated with the failed CMTS 12₂.

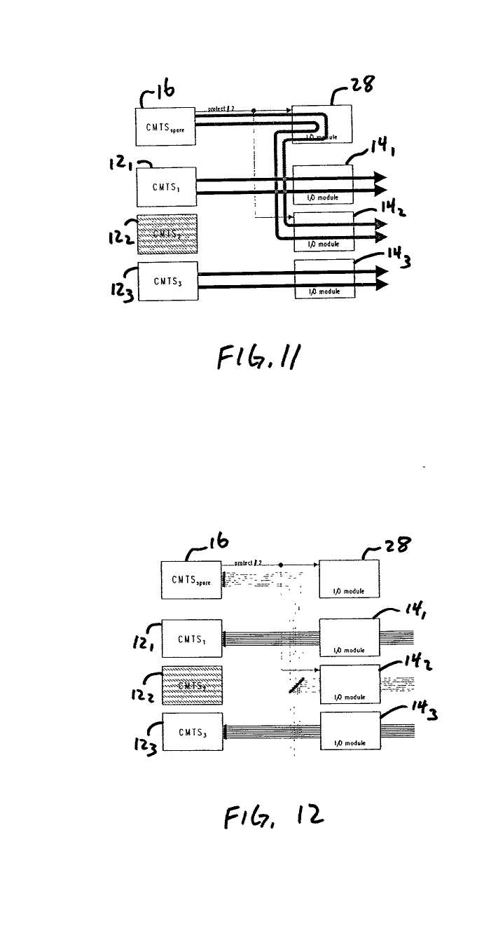

At stage 76, referring to FIG. 10 (that shows only three normally-active CMTSs 12₁-12₃ and their corresponding I/O modules 14₁-14₃) the control signal from the spare CMTS 16 causes the switches 40₂ and 60₂ (with one downstream path shown, and with it understood that the other downstream path and the upstream paths would be similarly affected) to switch from normal operation mode to “failure” mode. “Failure” mode can be entered even though a CMTS has not actually failed, e.g., is taken off-line for an upgrade. The control signal causes the switch 40₂ to disconnect the output port 50₂ from the working port 46₂ and couple the output port 50₂ to the failure port 48₂. Furthermore, the control signal causes the switch 60₂ to disconnect the spare-in port 62₂ from the working port 642 and couple the spare-in port 62₂ to the failed port 68₂. Consequently, signals to/from the CMTSs 12, 16 are routed as shown in FIGS. 11-12 from/to the 20 HFC plant 22.

As shown in FIG. 10, the daisy-chain connection is broken at the I/O module 142 corresponding to the failed CMTS 12₂. The signal from the spare CMTS 16 no longer flows through all the I/O modules 14₁-14_{N}, but rather flows through the I/O module(s) 14 between the spare CMTS 16 and the I/O module 14 corresponding to the failed CMTS 12, here I/O modules 14₁-14₂. I/O modules 14 further downstream (or further upstream, as the case may be, from the spare CMTS 16, i.e., I/O modules 14 more remote from the spare CMTS 16 than the module 14 associate with the failed CMTS 12) are disconnected from the spare CMTS 16. With the CMTS 5 122 failing, and the other CMTSs 12₁ and 12₃-12_{N} active, downstream and upstream signals are conveyed from/to the CMTSs 121, 12₃-12_{N}, and 16 through the I/O modules 14₁-14_{N}, as schematically shown for CMTSs 12₁-12₃ and I/O modules 14₁-14₃ in FIGS. 11 and 12. FIG. 12 schematically shows upstream signals not passing through the I/O module 28, although such signals would preferably pass through the I/O module 28. In the arrangement of FIG. 10, the spare CMTS 16 is connected for downstream signals through its I/O module 28, through the redundancy midplane 20, through the I/O module 14₁ of CMTS 12₁, through the redundancy midplane 20, to the I/O module 14₂ of the CMTS 12₂, and to the cable plant 22. For upstream signals, the connections are similar, but in reverse and through the midplane 18 instead of the midplane 20.

The physical switch-over from the failed CMTS 122 to the spare CMTS 16 preferably, although not necessarily, takes places as soon as the spare CMTS 16 is capable of sending synchronization messages to the communications link. A hardware-based synchronization scheme is used to help ensure that all CMTSs 12, 28 in the system 10 work from a common time reference. This helps ensure that the synchronization messages (which include a time stamp) produced by the spare CMTS 16 are aligned with those previously produced by the failed unit, here CMTS 12₂, such that cable modems associated with the CMTSs 12 transition to the spare CMTS 16 transparently. Using DOCSIS protocol implemented by the CMTSs 12, 16, synchronization (SYNC) messages across all CMTSs 12, 16 are synchronized to use the same timestamp to help the CMTSs' associated cable modems move to the spare CMTS 16 transparently.

At stage 78, the failed CMTS 12₂ is repaired/replaced/upgraded and is reinserted into the flow of signals to/from the HFC plant 22. A system operator initiates the switch back to the repaired/replaced CMTS 12₂ from the spare CMTS 16. The control signal is sent to the I/O modules 14, 28 to cause the I/O module 14₂ to transfer signals between its corresponding normally-active CMTS 12₂ and the HFC plant 22. The switches 40₂ and 60₂ switch back to the normal operation state, disconnecting the output port 50₂ from the spare CMTS 16 and reconnecting the HFC plant 22 to the CMTS 12₂.

Other embodiments are within the scope and spirit of the appended claims. For example, the discussion above focussed on CMTSs, but wireless and satellite modem termination systems may also be used. Also, while reference is often made to a CMTS failure, the spare CMTS may be used absent a failure of a CMTS, e.g., if a CMTS is to be updated or serviced despite no failure, or no failure significant enough to warrant shutting the CMTS down, occurring.

Other embodiments include a mechanism provided to rapidly detect CMTS failures using embedded cable modems 90, 92 as shown in FIG. 13. The output from each CMTS 12, 16 is provided to a diagnostic cable modem (CM) 90, 92 in addition to being supplied to the HFC plant 22. FIG. 13 shows the output of the CMTS 16 schematically, as its I/O module, through which signals to/from the CMTS 16 pass, is not shown. The diagnostic CM 90, 92 resides on the same cards as the CMTSs 12, 16, respectively, between the CMTSs 12, 16 and the RF redundancy planes 18, 20. Each CM 90, 92 has connections to the RF downstream and upstream RF links.

The CMs provide for rapid detection of any active CMTS that fails. If the CMTS does not maintain synchronization timing, then this is detected (preferably immediately, or at least substantially so) by the CM, and the CM produces an alarm to the CMTS. The CMTS will reset on receipt of this alarm and trigger the spare CMTS to take over.

The CMs also act as loopback devices to allow for offline CMTS testing. The spare CMTS can self test periodically when not in use. For example, the CMTS can transmit data to and receive data from the CM (operating in loop-back mode), as described below, without connections to other portions of the system. A replacement CMTS can be tested without disturbing user traffic before the replacement CMTS is restored to active duty.

The CMs also provide a mechanism to distinguish between cable plant faults and CMTS faults. The CMTS can monitor a difference in error rates between traffic for the local CM and traffic for those located in the HFC plant to identify plant related problems.

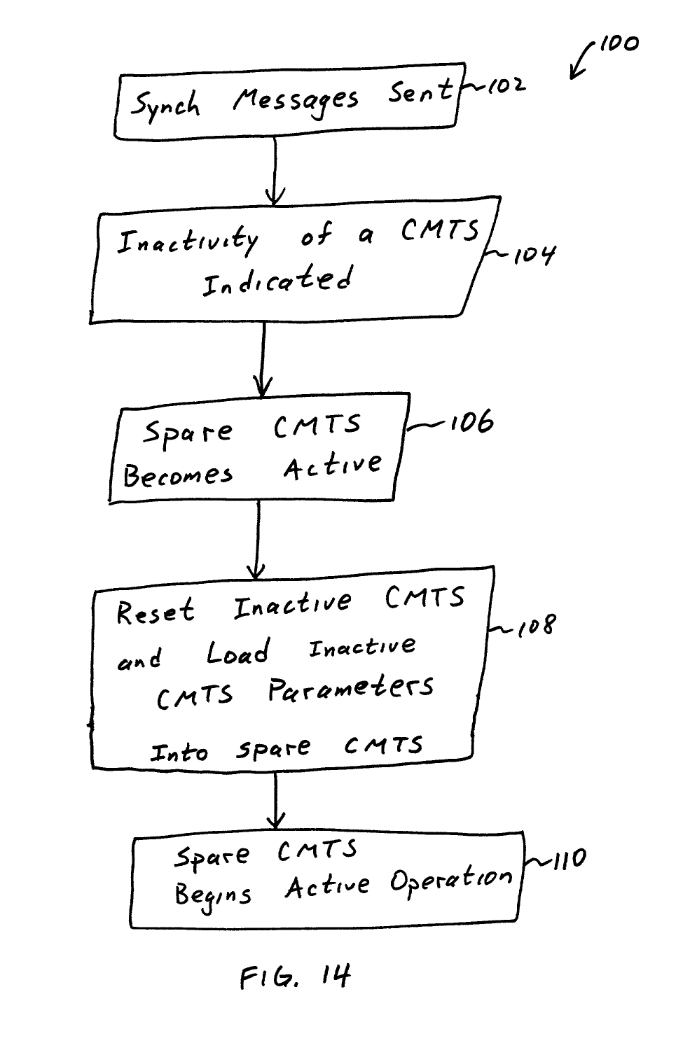

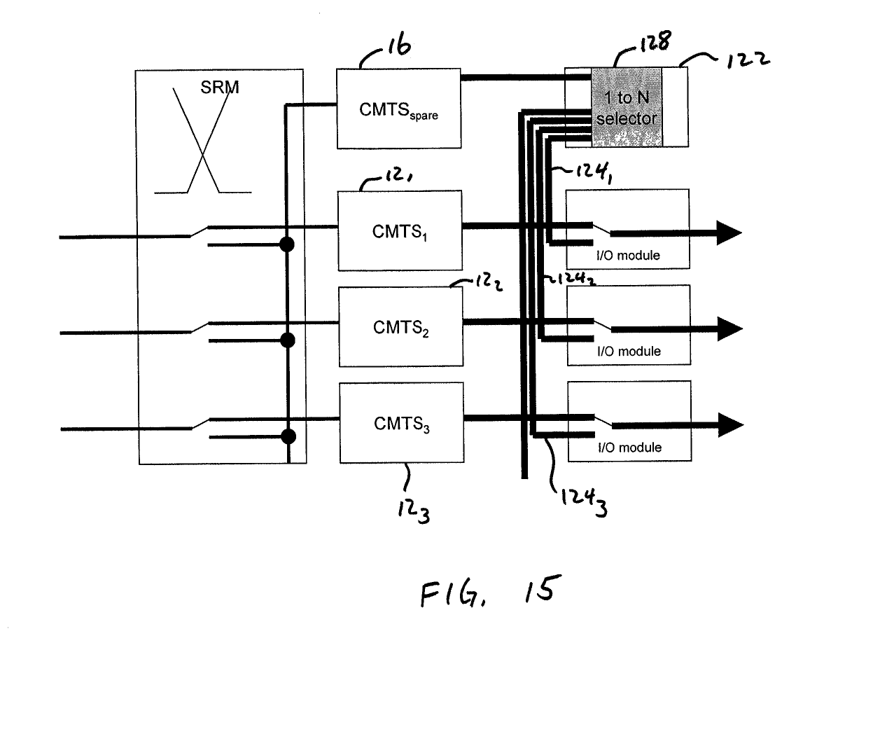

Referring to FIG. 14, with further reference to FIG. 1, a process 100 of restoring (or otherwise providing redundant) service in response to detecting a CMTS non-activity indication or inducer, e.g., a transmit failure, includes a stage 102, where synchronization messages (synch messages) are sent from an active CMTS, e.g., CMTS 12₂ to an associated diagnostic CM 90₂. At stage 102, synchronization messages are periodically sent to the diagnostic CM 90₂. The CM 90₂ responds to the received synch messages by starting a synch timer.

At stage 104, an error in the CMTS 12₂, or another event, e.g., signaling imminent non-activity of the CMTS 12₂, occurs causing the synch message not to be sent. Consequently, a synch message is missed at the diagnostic CM 90₂. In response to the missed synch message, the CM 90₂ sends an error signal to the CMTS 12₂. The CMTS 12₂ responds to the error signal sent from the CM 90₂ by asserting a request for a protection signal from the spare CMTS 16.

At stage 106, the spare CMTS 16 responds to the protection signal request sent at stage 104 by moving to an active state. The spare CMTS 16 further asserts a protection complete signal and sends this signal to the failed CMTS 12₂.

At stage 108, the failed, or otherwise imminently or currently non-active, CMTS 12₂ resets and the spare CMTS 16 loads parameters from the failed CMTS 12₂. The spare CMTS 16 updates its parameters to match those taken from the failed CMTS 12₂. The spare CMTS 16 further begins producing synch messages and sets an RF switch to map the spare CMTS output to the appropriate HFC segment associated with the failed CMTS 12₂.

At stage 110, the spare CMTS 16 begins full CMTS operation to transfer data between itself and the HFC plant 22. If an active CMTS becomes available, e.g., by repairing or replacing the failed CMTS 12₂, then that CMTS is operated in standby mode until being switched in to replace the spare CMTS 16.

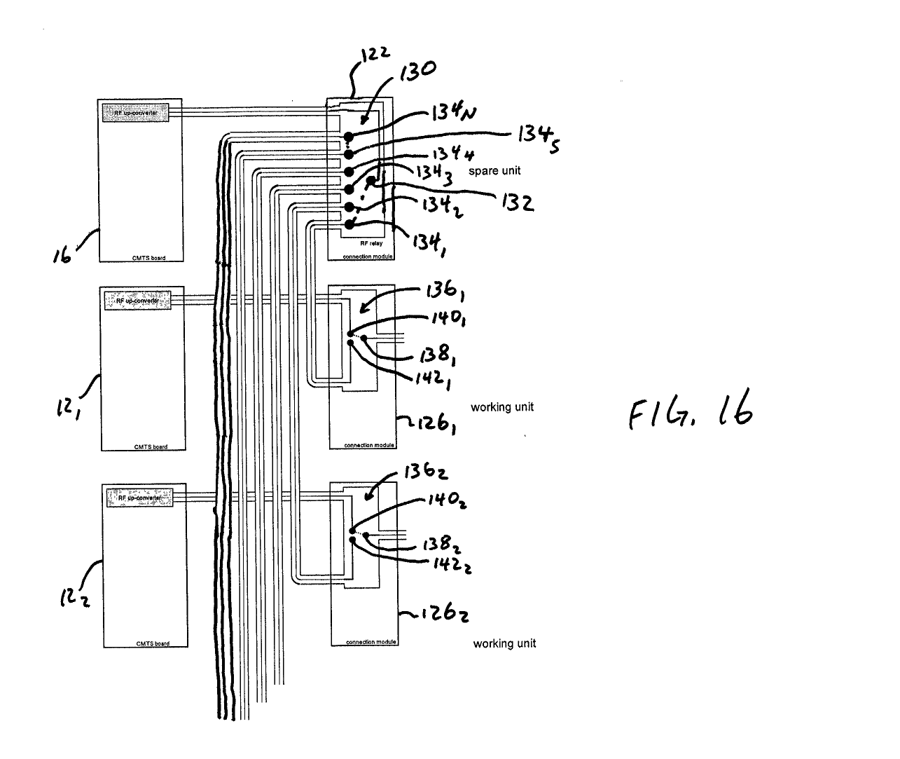

Still further embodiments are within the scope and spirit of the appended claims. For example, referring to FIG. 15, a path 120 connects the spare CMTS 16 with its associated I/O module 122 and separate paths 124₁-124₃ connect the I/O module 122 to each of three I/O modules 126₁-126₃ with three CMTSs 12₁-12₃ being operational. A simple selection on every I/O module 126 can pick either the normally-active CMTS's connection or the spare CMTS's connection (via the redundancy planes 18, 20 (FIG. 1)). A 1-to-N selector 128 in the I/O module 122 is configured to selectively connect the spare CMTS 16 to a desired one of the I/O modules 126, and thus to respective external physical interfaces.

Referring to FIG. 16, the 1-to-N selector 128 is schematically shown to include a 1-to-N switch 130 with a spare port 132 and N I/O ports 134₁-134_{N}. The spare port 132 is normally connected to a default I/O port 134, here port 134₁. Other ports, however, may be the default port such as a port approximately in the middle of the ports 134 to reduce average switch time from the default port 134 to the desired port 134. The switch 130 connects the spare port 132 to the appropriate I/O port 134 in a failure mode in response to a control signal received from the spare CMTS 16 according to a protect request received by the spare CMTS 16 associated with a failing CMTS 12.

Each I/O module 126 includes a switch 136 for selectively connecting to the modules associated CMTS 12 or to the spare CMTS 16 via the spare I/O module 122. Each switch 136 includes an output port 138, a working port 140, and a failure port 142. The switch 136 under normal operation couples the output port 138 to the working port 140 to route signals to/from the I/O module's associated CMTS 12. If an I/O module 126, e.g., 126₁, fails, then the switch 136₁ moves to a failure mode and couples the output port 138₁ to the failure port 142₁ to permit communication between the spare CMTS 16 and the HFC plant 22 (FIG. 1) via the I/O module 126₁.

Using this arrangement, in operation a process similar to that shown in FIG. 7 and described above is performed. In this case, however, at stage 76, the 1/0 module 126 corresponding to the failed CMTS 12 has its switch 136 convert to its failure mode, and the 1-to-N switch 122 couples the spare port 132 to the appropriate I/O port 134 (here 134₁) corresponding to the failed CMTS 12₁. No daisy chain connection is broken, just a connection from the spare CMTS 16 through the 1-to-N switch 130 through the appropriate I/O module 134₁ to the HFC plant 22 (FIG. 1) is made.

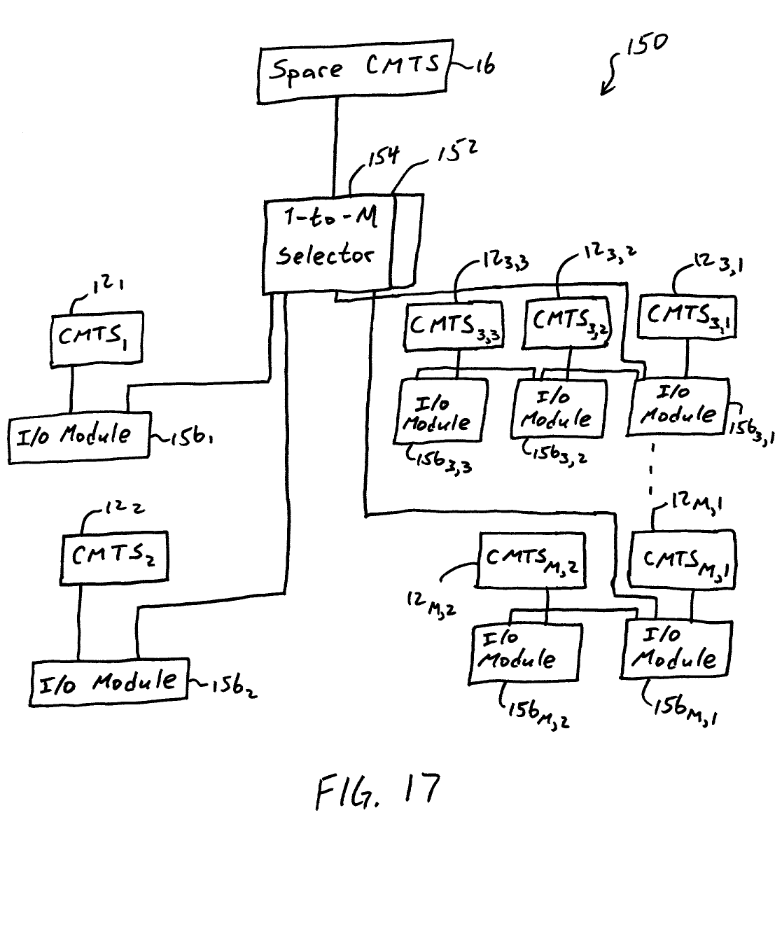

Still further embodiments are within the scope and spirit of the appended claims. Referring to FIG. 17, in a hybrid redundant CMTS system 150 the spare CMTS 16 is connected to its I/O module 152 that includes a 1-to-M selector 154. The system 150 includes I/O modules 156 arranged in a hybrid configuration, with M I/O modules 156 connected directly to the 1-to-M selector 154 of the I/O module 152 and some of the modules 156 being indirectly connected to the I/O module 152 in a daisy-chain fashion. Although not all I/O modules 156 are shown daisy-chain connected, all of the I/O modules 156 could be connected to at least one other I/O module 156 in a daisy-chain fashion. M I/O modules 156 are connected to the 1-to-M selector 154 as described with respect to FIGS. 15-16, and the daisy-chain connected I/O modules 156 are configured and connected as described above, e.g., with respect to FIGS. 4-6. As shown in FIG. 17, not all daisy chains need to have the same number of I/O modules 156; zero, one or more I/O modules 156 may be daisy-chain connected to I/O modules 156 that are directly connected to the selector 154. In operation, the I/O module 156 that corresponds to an imminently or currently inactive CMTS 12 is coupled to the spare CMTS 16 either directly (i.e., independently of (not via) other I/O modules 156) or through the daisy-chain of other I/O modules 156, as appropriate.

Still further embodiments are within the scope and spirit of the appended claims. For example, the I/O modules of the various figures may be included in the same circuitry, and/or on a common circuit board with the CMTSs.

What is claimed is:

1. A CMTS system for receiving signals from, and transmitting signals toward, a High-Frequency Coax plant, the system comprising:
a plurality of normally-active CMTSs each configured to receive and transmit modem-compatible signals;
a plurality of interface modules coupled to the normally-active CMTSs and configured to convey data toward the HFC from the normally-active CMTSs and from the HFC toward the normally-active CMTSs; and
a spare CMTS configured to receive and transmit modem-compatible signals;
wherein at least two interface modules are coupled to each other in a daisy-chain fashion to couple at least a first of the interface modules to the spare CMTS via at least a second of the interface modules to which the first interface module is daisy-chain coupled.

2. The system of claim 1 further comprising a switch mechanism configured to selectively couple the spare CMTS to at least two interface modules independently of any other of the interface modules.

3. The system of claim 2 wherein at least one of the at least two interface modules are further coupled to another interface module in a daisy-chain fashion.

4. The system of claim 2 wherein the switch mechanism is configured to, in response to a normally-active CMTS becoming at least imminently non-active, couple the spare CMTS to an interface module associated with the normally-active CMTS that is at least imminently non-active.

5. The system of claim 1 wherein each interface module corresponds to a respective normally-active CMTS, the interface modules each including an upstream input port and a downstream output port, and wherein each interface module is configured to couple its downstream output port and upstream input port to its respective normally-active CMTS while the respective normally-active CMTS is operational and to the spare CMTS otherwise.

6. The system of claim 5 wherein each interface module is configured to couple its downstream output port and upstream input port to its respective normally-active CMTS while bypassing the spare CMTS.

7. The system of claim 5 wherein the first and second interface modules are selectively coupled to each other in a daisy-chain fashion, the second interface module being configured to decouple the first interface module from the spare CMTS while the second interface module couples its upstream input port and downstream output port to the spare CMTS.

8. The system of claim 1 wherein the spare CMTS includes a diagnostic cable modem configured to detect errors in the normally-active CMTSs.

9. The system of claim 8 wherein the diagnostic cable modem is configured to test the normally-active CMTSs.

10. A CMTS system for receiving signals from, and transmitting signals toward, a High-Frequency Coax plant, the system comprising:
a plurality of normally-active CMTSs each configured to receive and transmit modem-compatible signals;
a plurality of input/output (I/O) modules each associated with a respective normally-active CMTS;
a spare CMTS configured to receive and transmit modem-compatible signals; and
coupling means for serially coupling at least two of the I/O modules associated with normally-active CMTSs to the spare CMTS.

11. The system of claim 10 wherein the coupling means is configured to selectively couple an input and an output of the spare CMTS to an output and an input of one of the I/O modules associated with one of the normally-active CMTSs that is at least imminently non-active.

12. The system of claim 11 wherein the coupling means is configured to selectively couple to at least a third of the I/O modules associated with a normally-active CMTS independently of the at least two I/O modules that are serially coupled by the coupling means.

13. A method of providing one-to-N redundancy for N normally-active cable modem terminal system (CMTS) data transfer units using a spare CMTS, the method comprising:
providing the spare CMTS and the N normally-active CMTS data transfer units;
providing coupling of at least two of the CMTS data transfer units to each other; and
monitoring the normally-active data transfer units for de-activation.

14. The method of claim 13 further comprising coupling at least one of M of the CMTS data transfer units to the spare CMTS in response to one of the N CMTS data transfer units being at least imminently de-activated, where M is less than N.

15. The method of claim 14 wherein the at least one of M of the CMTS data transfer units is coupled to the spare CMTS in response to one of the N CMTS data transfer units being de-activated.

16. The method of claim 14 wherein the at least one of M of the CMTS data transfer units is coupled to the spare CMTS in response to one of the N CMTS data transfer units failing.

17. The method of claim 14 wherein the at least one of M of the CMTS data transfer units is coupled to the spare CMTS using a one-to-M switch.

18. The method of claim 13 wherein coupling is provided to the spare CMTS of exactly one of the at least two of the CMTS data transfer units independent of any other CMTS data transfer unit.

19. The method of claim 13 further comprising:
coupling the spare CMTS to at least a selected one of the at least two CMTS data transfer units in response to the selected one of the at two CMTS data transfer units being at least imminently de-activated; and
de-coupling from the spare CMTS any CMTS data transfer units disposed electrically further from the spare CMTS than the selected one of the at least two CMTS data transfer units.

20. The method of claim 13 wherein the CMTS data transfer units each include a CMTS and an input/output module, and wherein the providing coupling includes providing daisy-chain coupling of the input/output modules of the at least two CMTS data transfer units.

21. A CMTS system for receiving signals from, and transmitting signals toward, a High-Frequency Coax plant, the system comprising:
a plurality of normally-active CMTSs each configured to receive and transmit modem-compatible signals;
a plurality of interface modules coupled to the normally-active CMTSs and configured to convey data toward the HFC from the normally-active CMTSs and from the HFC toward the normally-active CMTSs; and
a spare CMTS configured to receive and transmit modem-compatible signals;
a switch mechanism configured to selectively couple the spare CMTS to at least two interface modules independently of any other of the interface modules;
wherein at least two interface modules are coupled to each other in a daisy-chain fashion to couple at least a first of the interface modules to the spare CMTS via at least a second of the interface modules to which the first interface module is daisy-chain coupled; and
wherein each interface module corresponds to a respective normally-active CMTS, the interface modules each including an upstream input port and a downstream output port, and each interface module is configured to couple its downstream output port and upstream input port to its respective normally-active CMTS, while bypassing the spare CMTS, while the respective normally-active CMTS is operational and to the spare CMTS otherwise.
